(19) United States
(12) Patent Application Publication
(10) Pub. No.: US 2025/0232534 A1
(43) Pub. Date: Jul. 17, 2025

(54) METHOD OF PRELIMINARY, INTUITIVE AND AUTOMATIC IMAGE CAPTURING (SHOOTING) AND PROCESSING WITH THE POSSIBILITY OF USER TRAFFIC TARGETING

(71) Applicant: LIMITED LIABILITY COMPANY “DINA”, Moscow (RU)

(72) Inventor: Maxim Vladimirovich Zemtsov, Moscow (RU)

(21) Appl. No.: 18/702,010

(22) PCT Filed: Sep. 28, 2023
(86) PCT No.: PCT/RU2023/000287

§ 371 Date: Apr. 17, 2024

(30) Foreign Application Priority Data
Aug. 9, 2023 (RU) 2023120825

(51) Int. Cl. G06T 19/00; G06T 13/40; G06T 19/20; H04N 23/60; H04N 23/61

(52) U.S. Cl. CPC G06T 19/006; G06T 13/40; G06T 19/20; H04N 23/61; H04N 23/64; G06T 2219/2016

(57) ABSTRACT

The invention relates to a computer-implemented method of photo or video shooting with a digital device comprising at least one optical device, based on providing recommendations for professional framing. The method comprises stages of: receiving a data stream through the optical device on the digital device; processing the data stream using machine learning techniques using models trained on a plurality of images including at least composition information to recommend the best shot; shooting in automatic, semi-automatic, tracking shooting and guided shooting modes; wherein, in automatic mode, the shooting process is initiated by tapping on any area of the screen; in semi-automatic or tracking mode, shooting is carried out by combining the frame capture area and the three-dimensional frame of the shot; if in the automatic, semi-automatic and tracking modes there is no possibility to create a professionally composed shot, then the guiding shooting mode is turned on, in which three-dimensional shooting points are generated into an interactive real-time map for each user individually, with each point containing interactive information for obtaining a professionally composed shot, while the map is a 2D map or an AR map and/or a mixed reality map; the mixed reality view displays three-dimensional shooting points on a connected mixed reality relay device and wirelessly transmits guiding signals of graphic output to the projection screens of the mixed reality devices, directing the user to successful shooting angles and advising on how and in what position to hold the shooting device while the algorithm takes a shot; sending the shots obtained during shooting, in at least one of the modes, to the buffer of pre-saved shooting results, where rapid post-processing is carried out and the resulting shooting result is displayed on the screen; further interacting with the results are recorded and processed using reinforcement learning methods to further improve shooting processes and results. The invention provides professionally composed photo/video shots without subsequent post-processing.

### FIELD OF THE INVENTION

This technical solution relates to the field of artificial intelligence (hereinafter referred to as AI), which aims to most accurately reproduce the functioning of the human brain in the processes of decision-making, perception and determination of visual objects, images, compositions and other creative aspects intuitively understood by humans. Such solutions operate based on machine learning principles and algorithms, including deep machine learning.

In particular, the technical solution relates to the field of computer technology, in particular, to a method for preliminary, intuitive and automatic image capturing (shooting) and processing with the possibility of user traffic targeting using AI systems.

### PRIOR ART

The source of information US2019208117 A1, Apr. 7, 2019 is known from the prior art, which discloses a method for providing recommendation information for capturing images. The method comprises detecting by an electronic device the face of a subject on a preview screen viewed by a camera of the electronic device and displayed on a display of the electronic device, identifying information about the current composition of the preview screen based on the detected face of the subject on the preview screen. The recommended photographic composition is determined based on the current composition information of the preview screen and the composition information that is located at the center and visual composition guidance is provided on the display of an electronic device, the movement of which is limited in one plane, based on a specific recommended shot. Data processing occurs on a server, meaning that internet access is required to obtain shooting recommendations.

The claimed technical solution differs from the known solution in that the interface does not contain elements that trigger shooting upon pressing on them, that is, the system itself determines the moment of pressing the “shutter button” and the interface can, in a particular case, be tactile to initiate the shooting process automatically or, generally, for service purposes. Panning and device movement in space are facilitated by the method in all available degrees of freedom and planes. Interactions with the results are recorded and processed using reinforcement learning methods to further improve shooting processes and results. The stated technical solution uses the principle of decentralization of artificial intelligence calculations on devices without direct connection to servers (AI on the Edge). Thus, a significant part of the calculations and processing of incoming information is carried out by the system on the digital device itself, regardless of whether there is a network connection or not, and the obtained reinforcement learning results available for public exchange can be synchronized directly with other devices via an open internetwork channel (for example, via a Wi-Fi channel without access to the Internet) or via the cloud when the connection is available. In addition, the claimed method comprises a guided shooting mode, in which three-dimensional shooting points are generated into an interactive map in real time for each user individually, with each point containing interactive information to obtain a professionally composed shot, and the map is a two-dimensional map or AR-map and/or a mixed reality map, wherein the mixed reality view displays three-dimensional shooting points on a connected mixed reality relay device and wirelessly transmits guiding signals of graphic output to the projection screens of the mixed reality devices, directing the user to successful shooting angles and advising on how and in what position to hold the shooting device while the algorithm takes a shot.

### SUMMARY OF THE INVENTION

The technical problem addressed by the claimed technical solution is the creation of a computer-implemented method for photo or video shooting with a digital device comprising at least one optical device, based on providing recommendations for professional framing that does not require subsequent selection and post-processing.

The technical result consists in obtaining professionally composed photo or video shots, without subsequent post-processing. From henceforth, a shot means both a static photo shot and a video.

In a preferred embodiment, a computer-implemented method of photo or video shooting with a digital device comprising at least one optical device, based on providing recommendations for professional framing, comprising the stages of:
receiving a data stream through the optical device on the digital device;
processing the data stream using machine learning techniques using models trained on a plurality of images including at least composition information to recommend the best shot;
shooting in automatic, semi-automatic, tracking shooting and guided shooting modes;
wherein, in automatic mode, the shooting process is initiated by tapping on any area of the screen; in semi-automatic or tracking mode, shooting is carried out by combining the frame capture area and the three-dimensional frame of the shot; if in the automatic, semi-automatic and tracking modes there is no possibility to create a professionally composed shot, then the guiding shooting mode is turned on, in which three-dimensional shooting points are generated into an interactive real-time map for each user individually, with each point containing interactive information for obtaining a professionally composed shot, while the map is a 2D map or an AR map and/or a mixed reality map;
the mixed reality view displays three-dimensional shooting points on a connected mixed reality relay device and wirelessly transmits guiding signals of graphic output to the projection screens of the mixed reality devices, directing the user to successful shooting angles and advising on how and in what position to hold the shooting device while the algorithm takes a shot;
sending the shots obtained during shooting, in at least one of the modes, to the buffer of pre-saved shooting results, where rapid post-processing is carried out and the resulting shooting result is displayed on the screen;
further interacting with the results are recorded and processed using reinforcement learning methods to further improve shooting processes and results.

In a particular embodiment, the optical device is a camera.

In another particular embodiment, the optical device includes at least one camera.

In another particular embodiment, the data stream contains at least metadata, including EXIF.

In another particular embodiment, an individual portrait profile is created by scanning the face and at least one flattering posing option is determined.

In another particular embodiment, when detecting a living object in the frame that corresponds to a configured individual portrait profile, the parameters of this profile will be taken into account when shooting.

In another particular embodiment, when detecting more than one living object in the frame, a living object with a saved portrait profile is selected first.

In another particular embodiment, in the automatic shooting mode, when tapping on any part of the screen, the finger is held and the digital device is moved in different planes and directions.

In another particular embodiment, the shooting result is displayed on the screen when the finger is lifted.

In another particular embodiment, in the semi-automatic shooting mode, the three-dimensional frame is a fixed reference point.

In another particular embodiment, in the semi-automatic shooting mode, a three-dimensional shot frame moved and fixed in space is used as a reference point and the frame capture area and the three-dimensional shot frame are overlapped.

In another particular embodiment, in the semi-automatic shooting mode and tracking shooting mode, when a living object is detected in the focus coverage area, it is highlighted with an outline, then a three-dimensional mannequin is graphically drawn on top of the object and the mannequin animatedly changes its pose to a more flattering one.

In another particular embodiment, if more than one living object is detected, the user can select a priority object.

In another particular embodiment, in the tracking shooting mode, the three-dimensional frame is the tracking one.

In another particular embodiment, in the tracking shooting mode, the tracking frame capture area and the tracking three-dimensional shot frame of the shot are stabilized relative to the central point and overlapped.

In another particular embodiment, a couple of seconds before and after stabilization and overlapping, a series of shots and/or video is taken.

In another particular embodiment, a three-dimensional frame indicates the orientation of the camera for obtaining a professionally composed shot.

In another particular embodiment, the operator can select the guided shooting mode after starting the system.

In another particular embodiment, in the guided shooting mode, a map is launched, where the user selects the desired point, moves the device closer to this point, and automatically switches the shooting mode to the one saved at this point.

In another particular embodiment, a two-dimensional map displaying three-dimensional shooting points can be displayed in full screen or as a thumbnail; the thumbnail can be moved to any location on the screen.

In another particular embodiment, the AR map indicates shooting points taking into account the radius to them: within a radius of up to 50 meters, a three-dimensional object of the shooting point is shown with detailed interactive information, such as: information about the point rating, information about the point author, information about the point lifetime; within a radius of 50 meters to 5 kilometers, three-dimensional objects of a cluster of shooting points are displayed with detailed information, such as information on the number of points in the cluster, the distance to the cluster of points and information on the lifetime of the cluster of points.

In another particular embodiment, the display of the shooting result occupies the central part of the screen, wherein free areas of the screen remain active and return to the mode used for shooting upon tapping on these active areas.

In another particular embodiment, the obtained shooting result is stored in a buffer until the next session for outputting the shooting results, which are queued for sorting.

In another particular embodiment, to save the shooting result, the shooting result is to be dragged to the right.

In another particular embodiment, to delete the shooting result, the shooting result is to be dragged to the left.

In another particular embodiment, when interacting with shooting results, training can be carried out both on the device and on the server.

A computer-readable medium containing instructions executable by a processor, wherein the processor is configured to implement the steps of the method described above.

As used herein, a system is a computing device that includes at least a processor and a memory, wherein the memory contains instructions that are executed by the processor. In general, a computing device comprises such components as one or more processors, at least one memory, data storage, input/output interfaces, input/output means, network communication means.

The device processor executes main computing operations, required for the functioning of the device or functionality of one or more of its components. The processor runs the required machine-readable commands contained in the random-access memory.

The memory is typically in the form of RAM and comprises the necessary program logic which ensures the required functionality.

The data storage means can be made in the form of HDD, SSD, RAID, networked storage, flash memory, optical drives (CD, DVD, MD, Blue-Ray disks), etc. The means enables the long-term retention of different information, such as the above-mentioned files with user data sets, databases containing the records of time intervals measured for each user, user IDs, etc.

The interfaces are the standard means for connection and communication with the server side, e.g. USB, RS232, RJ45, LPT, COM, HDMI, PS/2, Lightning, FireWire, etc.

Selection of interfaces depends on the specific embodiment of the device, which could be a personal computer, mainframe, server cluster, thin client, smartphone, laptop, etc.

Any embodiment of the system for the described method must use a keyboard as its input/output means. The keyboard can have any known hardware design: it can be a built-in keyboard used on a laptop or netbook, or a stand-alone device connected to a desktop, server or other computer device. In this case, the connection can be wired, where the keyboard's connecting cable is connected to PS/2 or USB port located on the system unit of a desktop computer, or it can be wireless, where the keyboard exchanges data over a wireless channel, such as a radio channel, with the base station which, in turn, is directly connected to the system unit, for example, via a USB port. In addition to the keyboard, the following can also be used as the input/output means: a joystick, display (touch-screen display), projector, touch pad, mouse, trackball, light pen, loudspeakers, microphone, etc.

Networking means are selected among devices that ensure receiving and transmitting data over a network, e.g. an Ethernet card, WLAN/Wi-Fi module, Bluetooth module, BLE module, NFC module, IrDa, RFID module, GSM modem, etc. The means enable data exchange through wire or wireless data communication channel, e.g. WAN, PAN, LAN, Intranet, Internet, WLAN, WMAN or GSM.

The components of the device are interfaced via a common data bus.

The role of the manipulator of the device on which the method is implemented can be played by either a human user (operator) (hereinafter referred to as the operator), or a software and hardware complex for autonomous maneuvering and movement in space (hereinafter referred to as SHC) of a device made like an automated drone, UAV, robot, etc. (hereinafter referred to as machines).

Areas of application of the method: amateur photo and video shooting, professional camera photography and video shooting, computer vision, where a creative approach to image analysis is required, including medicine (ensuring the work of promising eye implants), as well as such borderline applications as, for example, precise AR positioning or generation of photorealistic spaces for 3D design, film and gaming industry, etc.

### DESCRIPTION OF DRAWINGS

The embodiment of the invention will be described below in accordance with the accompanying drawings, which are presented to explain the essence of the invention and in no way limit the scope of the invention. The following drawings are attached to the application:

FIG. 1 illustrates a storyboard of the process of interacting with the interface in semi-automatic shooting mode.

FIG. 2 illustrates a storyboard of the process of interacting with the interface in semi-automatic shooting mode, with a living object in the frame, for example, a person and/or an animal.

FIG. 3 illustrates the display in the guided shooting mode of an active map of shooting points (angles) in augmented reality (hereinafter referred to as the AR map).

### DETAILED DESCRIPTION OF THE INVENTION

The following detailed description of the invention embodiment provides numerous details of the embodiment in order to ensure a clear understanding of the present invention. However, to those skilled in the art, it will be obvious how the present invention could be used, whether with or without these details of its embodiment. In other cases, the well-known methods, procedures, and components have not been described in detail to avoid overcomplicating the understanding of this invention's features.

In addition, the above presentation will make it clear that the invention is not limited to the presented embodiment. Numerous potential modifications, changes, variations, and substitutions, that retain the essence and form of this invention, will be obvious to those skilled in the art.

In addition to the basic tasks of accurately determining objects, distance, depth, visual odometry and color correction, the claimed method solves the issue of correct framing, choice of composition, exposure, shooting point and angle (hereinafter referred to as angle). It eliminates the need to sort and post-process images. It can also simulate the work of various optics.

For the operator, the method implemented by the system is a simple interaction functionality. When the digital device camera operator points at the shooting area of interest, the system analyzes the available space around and begins to interact with the operator in four modes: automatic, semi-automatic, tracking and guided shooting mode. Each mode is described in detail further in the application materials.

The method comprises stages in which shots for the operator are made automatically by the system. The interface of the system used to implement the method does not have the usual shutter button.

Objects are recognized in the frame, the main one is selected, the genre, successful composition, exposure, settings and color correction, point and angle are determined.

Simultaneously, external atmospheric (weather, insolation, celestial navigation) and time parameters are monitored. All these data are collected for processing and framing. All image streams from available cameras on a digital device are synchronized. A perspective frame for shooting is determined, taking into account the movement of the device and the operator himself with the device in all planes with the maximum available angle.

In the process of pointing the camera, shooting and processing at the software level, the work of camera lenses with different focal lengths that are not available in hardware (computer optical correction) is simulated.

Digital devices feature edge AI computing (hereinafter-Edge AI), also known as “Edge AI” or “AI on the Edge” (there is no established AI term at the time of disclosure). When a significant part of the calculations and processing of incoming information occurs on the digital device itself. Edge AI does not require a network connection and/or Internet connection, meaning it can work without an Internet connection.

Wherein exchange between digital devices within the network can be carried out by direct synchronization with other devices via open internetwork channels, such as Bluetooth, Wi-Fi, etc. without access to the Internet, or via the Internet directly or through the cloud (hereinafter—the Server), the exchange method is determined automatically, making a choice in favor of maximum throughput. Digital devices exchange their results, including the results of reinforcement learning (necessary for continuous comprehensive improvement of the system), available for public exchange within the network.

To ensure an increase in the speed of real-time computing, they provide the possibility of interaction with other devices included in the system network to distribute computing power between them upon request (hereinafter referred to as fog computing).

Each time interacting with the operator, the system trains and adapts to the operator's preferences and tastes, becoming an individual tool and developing a unique shooting style. Wherein the system is also trained globally throughout the entire network to improve the operation of the algorithm. And if the user limits the transfer of data about interaction with the system to train personalized improvements, then he will only be able to take advantage of the available global improvements.

Any words in the text indicated in the singular may also be read, interpreted and construed as words with the same meaning in the plural, unless the context clearly indicates the meaning of the word in the singular.

The term operator means not only the system user and/or the owner of the device on which the system is installed, but also any other person to whom the user and/or owner entrusted the device for shooting.

To describe the claimed method, the most common option for manipulating the device at the time of disclosure of information is presented—“System and Operator”. However, all the rules, algorithms and examples described above are applicable for the combination—“System and Machine”.

The proportions of the shot directly depend on the physical proportions of the camera matrix. The standard value for most cameras is 4:3. The system at the software level, by framing, can use, according to user preferences, any other frame proportions, for example, 3:2, 16:9, 1:1 or arbitrarily specified values in the photography settings.

A device is any digital device or machine equipped with cameras. The device must have a central processor, graphics processor, RAM, and special chips/modules for wireless remote and intranet data exchange.

According to the choice of the operator in the system settings, indicating whether he is right-handed or left-handed, all tactile interface elements that need to be pressed and/or held are “mirrored” from right to left or vice versa, providing a better user experience with the system.

The concept of a labeled dataset is understood as a set of shots in which all available objects, as well as any other set of labeled data, are manually or programmatically marked graphically (with color and/or border) and/or otherwise labeled. This set is usually used in machine learning to train neural networks and then obtain ready-made neural network models. Wherein the success of machine learning directly depends on the amount of initial information: the more information there is, the better the AI will develop.

To begin to describe the method of photo or video shooting with a digital device that comprises at least one optical device, based on providing recommendations for professional framing, it is worth considering the main basic optical capabilities of devices using the system and explaining the possibilities of spatial interaction of the device system with the surrounding environment as part of the shooting process.

The number of cameras a device has is directly related to the capabilities of the form factor of the device itself, its compactness and the thickness of the camera lens socket. Lenses come in fixed and variable focal lengths. Unlike fixed lenses, variable lenses have a complex design that requires telescopic extension of the lenses inside the lens to change the focal length. Compact devices are often equipped with one or a series of cameras with fixed lenses due to the size capabilities of the devices. This takes into account cameras located on any of the sides (front, rear or lateral) of the device.

A single-camera option is usually, but not necessarily, a standard lens with a wide-angle focal length equivalent of about 26 mm (about 85° viewing angle), closest to the focal length of the human eye.

A dual-camera option usually, but not necessarily, comes with a standard and zoom lens, with a standard focal length equivalent of 52 mm (viewing angle of about 47°), and combinations of two standard, standard and wide-angle lenses, with an ultra-wide focal length equivalent of 13 mm (viewing angle about 120°), etc.

A three-camera option, where all three types of lenses are used.

An option with a large number of lenses, as a rule, these are options for intermediate focal lengths or promising options for wider coverage or longer focal length.

To analyze the surrounding situation and make decisions on composition and exposure, the method uses all cameras of the device with available frame coverage areas.

The coverage areas (field of view) and the frame scale that can be recorded, depending on the selected focal length of the camera lens, may be different.

Thus, the field of view of a wide lens frame covers a larger shooting area compared to the human gaze, and the effect of distance is obtained.

The field of view of a standard lens covers a smaller shooting area and, in comparison with the human gaze, the image obtained is very close in perception.

The field of view of a zoom or telephoto lens covers an even smaller shooting area, compared to the human gaze, resulting in a zooming effect.

Alternative options are also possible, if there are hardware capabilities for placing a larger number of fixed lenses and/or using lenses with variable focal lengths, and it is also applicable to change the focal length at the software level, simulating the operation of various lenses and their focal lengths.

A wide lens coverage area is most often used in landscape photography to capture the scale of the scene being photographed.

In the interface, depending on the operator's selected settings, a magnification indicator (zooming in/out) of the frame's field of view may appear. When tapping on a special area once, the system will switch between the available lenses of the device. When tapping on and holding a special area, an animated dial will open. By moving this scale, the required image magnification can be accurately selected manually using the hardware capabilities of optical and digital zooming, incl. generative zooming.

A standard lens coverage area is used for multi-genre photography and is the most common.

With a zoom or telephoto lens, this coverage area is most often used in portrait photography or for shooting distant objects, including close-ups.

Further, it is worth noting that before and during the filming process, when the method runs, a lot of input data is analyzed, such as images from cameras, geolocation data, data from a gyroscopic sensor, accelerometry data, visual odometry, available terrain map relief. Thanks to the mentioned data, the process of movement of the device and the operator in space is coordinated.

The system takes into account the dynamic “tracking” panning technique in this way. This technique is used to move a device in three planes, taking into account roll, yaw and pitch relative to the center of the device, that is, its movement and rotation along all three axes X, Y, Z.

The stationary panning technique of “looking around” the operator is also taken into account. This technique is used to allow the device to move freely around the operator, with restrictions on collision with natural obstacles.

Also, the dynamic panning technique of “looking around” the object is taken into account. This technique is used to allow the operator and the device to move freely around the object, with restrictions on collision with natural obstacles.

That is, when making decisions about where and from what angle it is better to make perspective shooting, the system implementing the method is not limited solely to the information captured by the camera viewfinder, but thanks to spatial coordination, it can search for promising options for shooting beyond the coverage area and offer it to the operator to move to the desired shooting point.

Thus, the claimed method comprises essential features that visual information from all cameras with all available focal lengths is used simultaneously. Wherein to create perspective shooting plans, the system has no restrictions on the degrees of freedom in panning.

The system, as an end-to-end shooting solution, is primarily positioned as a customized solution that interacts with the device owner, learns, and strives to meet the user's expectations for creative vision in shooting. However, it can also be used in multi-user solutions.

To improve the user experience of interacting with the system at the time of its first launch on the device, the operator is asked to create an individual portrait profile. It is worth saying that if this step is skipped at the beginning, the user can return to it at any other time convenient for him.

Portrait profile is a combination of a detailed scan of the cameraman's face, selection of the best side and retouching settings that meet the user's expectations and are considered natural and the most flattering from the user's point of view for portrait photography.

The user is not limited to just one portrait profile; at his discretion, the required number of portrait profiles of other people, for example, close relatives, friends and any people in general, can be added to the system on the device. Scanning and fine-tuning of additional portrait profiles occurs solely with the consent of the operator.

The system is built in such a way as to ensure maximum protection of data associated with portrait profiles, which are stored in encrypted form exclusively on the device itself, access to which is provided by a key password or other user authentication systems available on the device, and are not synchronized in the cloud, nor with other devices.

If the device is completely lost, individual portrait profiles will also be lost, because this is the only type of data that cannot be synchronized when reinstalling the system on a new device. In this case, the user will be required to re-create a portrait profile on a new device.

However, the user can change this security setting in the settings and allow the system to sync portrait profiles to secure cloud storage.

To create a portrait profile, the operator films (“scans”) his face using the front camera on a device he holds in his hands. Interface elements tell the operator how to turn his head to accurately scan all the features of the head and facial features. Hints are made in the form of interface elements, and consistently indicate full rotation of the head around, full-face and profile turns, lifting and tilting the chin, reproduction of various emotions: sadness, neutral state, slight smile, confident smile, wide smile, laughter, closed eyes, normally open eyes, wide open eyes.

The AI system core (hereinafter—the Core) analyzes the received data and, comparing with professional portrait profiles that are part of the system's professional datasets, determines the most flattering posing option(s) for the user. The operation of the core will be discussed further.

The user's task at the next stage is to select from the proposed options, in the “carousel” mode, the most accurate option for the “working” side of the portrait profile. Then the user should adjust the parameters of the face and head and save the result in the system.

Now, during shooting, when a living object is detected in the frame that corresponds to the configured portrait profile, the user's preferences for angle and retouching will be taken into account to take an ideal portrait shot.

This solves the problem where the user asked another operator to take a portrait photo, and the result did not meet his expectations.

If the system detects more than one living object in a frame with portrait profiles set, the system will first select the portrait profile of the user/device owner as a priority, then the operator can independently select the main object and build the shot in accordance with its portrait profile, while trying as much as possible to match the rest of the portrait profiles defined in the frame.

As part of the step-by-step algorithm for creating an individual portrait profile, the operator starts the portrait profile creation mode, then the first scanning is run, points, signs and features are determined, the scanning is repeated, securing and validating the data obtained during the first run, and versions of the digitized model of the operator's face/head are created, for subsequent selection of the appropriate option in the “carousel” and application of the settings for the parameters of anthropological features and retouching. After which the operator saves the resulting portrait profile and exits the mode.

The key and central element of the system is the AI system core. The task of the core is to process the incoming data stream in order to obtain output options for the composition and exposure of the shot, figuratively speaking, to help the device see the world around it creatively, as a professional photographer and/or video operator would do.

Thus, initially, photo/video streams are collected from all available cameras of the device and, using an intermediate layer of preinstalled, trained convolutional neural network models (hereinafter referred to as CNNs), all objects are marked (hereinafter-detected) in the frame streams, the frame depth, the distance between objects are calculated, individual portrait profile(s) are detected (if any), the priority object in focus is determined, the illumination of the scene is assessed, and a single matrix of images from all cameras is compiled with markings by coverage areas.

Then data is collected from the device: from the gyroscope about the position in space, from GPS/GLONASS sensors about geolocation, as well as accelerometry and visual odometry, if necessary, when the first two types of data are not sufficient, for example, when manipulating the Machine through the SHC.

Next, image metadata is downloaded from the streams, which include, but are not limited to, the following data describing the conditions and methods of obtaining, authorship, etc.: manufacturer of the digital device (camera), model of the digital device (camera), authorship, exposure, aperture, photosensitivity in ISO units, flash use, frame resolution, focal length, matrix size, equivalent focal length, depth of field, date and time of shooting, camera orientation (vertical or horizontal), white balance type, exposure, histogram parameters, location address, spatial position and etc. (hereinafter-EXIF metadata).

If there is an Internet connection, data is downloaded from open sources via API, incl. forecasts for the next 7 days in case of lack of Internet connection, about external atmospheric conditions (weather, insolation and celestial navigation). Together, this data provides an accurate understanding of the light level of a scene and the duration of a certain state, and also helps to accurately predict and select the correct composition and exposure, for example, for shooting during the “golden hour” period (the first hour after sunrise and the last hour before sunset, although the exact duration varies depending on the time of year) or Milky Way timelapse astrophotography (the so-called “night sky timelapse”).

As a backup, if individual portrait profiles have not yet been defined at the stage, all pre-installed individual portrait profiles are uploaded into the general process.

Then the core supports the calculations by selecting an appropriate, trained neural network model from the database of trained neural models, the description of which will be presented in the analysis of the system operation algorithm in automatic shooting mode.

During the continuous cycle of collecting core data on shooting results for reinforcement learning, which will be described in detail as part of the description of the system operation in terms of processing the shooting result(s), the core receives intermediate results of neural models of reinforcement learning based on personalized user data about results and activity in social media, a description of which will be presented in the system operation in automatic shooting mode. The user provides access to the mentioned data at his own choice, and this choice can be changed at any time in the privacy settings of the system.

As mentioned earlier, as part of the core operation, at the final step of the deep machine learning algorithm, data about shooting points on the AR map and their ranking is uploaded to develop alternative composition and exposure options.

Thus, during processing, the core can provide three outputs to the system:
the possibility to create a shot is present, composition and exposure options are provided;
the creation of a shot is possible, for which the system needs more data (to expand the coverage area);
there is no possibility to create a high-quality, professionally staged shot, for example, when the image is completely out of focus, in which case the system switches to the guided shooting mode, which will be described in detail below.

To conclude the description of the AI system core, it is worth pointing out that at the hardware level, to provide edge AI calculations, the system works in conjunction with a machine learning controller and automatically distributes tasks between the so-called “neural engine” system, central and graphic processors.

By this point of the disclosure, all the basic principles and key elements of the system have been described and defined to provide a more complete understanding of the new method of photo or video shooting with a digital device comprising at least one optical device, based on providing recommendations for professional framing.

After starting the system, the operator selects shooting modes: automatic, semi-automatic, tracking and guided shooting mode. Below are examples of the above modes.

In automatic shooting mode, the operator just needs to point the camera at the desired subject, tap on any place on the screen in the active zone and, holding the finger of the right or left hand (regardless of whether he is right-handed or left-handed), smoothly move the device in different planes and directions, according to the description of the panning methods above, at the user's discretion.

At the moment of panning the shot, the incoming image stream is actively captured along with metadata. Simultaneously neural networks detect all objects in the frame, user portrait profiles, if any, their priority, position and distance, depth of field, scene illumination, external atmospheric conditions (weather, insolation and celestial navigation, etc.). After which the AI system core processes the input data and provides the system with options of the most successful combinations of composition and exposure.

During automatic shooting, shots corresponding to best combinations are sent to the buffer of pre-saved results, where rapid post-processing occurs.

And after the user lifts his finger, the system displays the result(s) obtained on the interface screen for the user to judge.

The selection of results and a detailed description of the system operation algorithm in terms of processing the shooting result(s) will be discussed further in the text.

Delving into the details of the method, it is worth analyzing the process of obtaining data about the corresponding trained neural network model.

The database (hereinafter-DB) of labeled datasets, from which the learning process begins, is divided into three groups:
genre datasets from selected professional shots published throughout the history of world photography;
shots from social media that pass the minimum validation threshold (depending on the genre, the threshold value of a certain validation parameter (likes, comments, reposts, clicks, transitions, etc.) may change (the process of determining validation parameters is not disclosed for commercial secret reasons) fall into genre datasets with subsequent markup;
genre datasets compiled from shots of system users.

The database of labeled datasets is processed by machine learning methods designed to create trained models, incl. supervised learning method, for example, the previously mentioned CNNs, which excel at recognizing and identifying images.

A model in machine learning (ML) is a set of artificial intelligence methods, the characteristic feature of which is not the direct solution to a problem, but learning in the process of applying solutions to many similar problems.

Neuromodels trained to recognize images and their compositions depending on filming genres, as well as datasets, are distributed in a single database into three levels:
models of professional composition (in the world of photo/video shooting there are over twenty well-known compositional rules and there is no need to describe each separately as part of disclosing information about the claimed method) and exposure of genre photography, which also includes a group of professional portrait profiles,
models of popular composition and exposure in genre photography, trained on popular shots from social media,
models of custom composition and exposure of genre photography, trained on continuously updated user shots.

Thus, the core selects the appropriate trained neural network model from the database of trained neural models, depending on the input data processed by the core.

Simultaneously, as mentioned earlier, to simulate camera lenses that are not available on the device, so-called computer optical correction is used. To do this, they use trained models of generative adversarial networks (hereinafter—GANs), which generate shots that imitate the operation of lenses.

GAN consists of Generator and Discriminator neural networks that iteratively compete with each other in the process of creating a realistic version of the image. The Generator strives to create an imitation of distortion and approximation of objects distant from each other by the depth of field, corresponding to existing lenses, and the Discriminator, in turn, cuts off unrealistic versions that are not consistent with the images produced by existing lenses.

GAN models are also accumulated in the core, and are used according to the scenario, at the stage of rapid post-processing, when an option of the identified composition is intended for use outside the hardware focal length, and also when the operator wants to program a focal length different from the hardware one.

Thus, during core processing, the system in automatic shooting mode can provide two outputs:
the possibility to create a shot is present, composition and exposure options are provided;
there is no possibility to create a high-quality, professionally staged shot, for example, when the image is completely out of focus. In this case, the system displays a warning on the screen that the shot cannot be “captured” under the same conditions, and displays in the interface the options necessary to move the device in space to capture more data (expand the coverage area). And if this does not help, then the system switches to guided shooting mode, which will be described in detail below.

In the case of the first output, the core transmits to the system generated options of successful compositions and exposures, which are sent to the buffer of pre-saved results, where rapid post-processing occurs using genre settings (such as brightness, contrast, clarity, etc.; industrial standards for the use of such parameters have already been developed for all genres in the photo/video industry, therefore, we will not dwell on this describing the claimed method, as part of the disclosure of information) and, if necessary, using GANs (simulating lenses) and GANs (simulating artistic style).

The latest GANs have the same image generation mechanism as lens-simulating GANs, only trained on the artistic styles/techniques of famous photographers and videographers, as well as popular photographers and amateur videographers from social media.

After the operator lifts his finger, the system displays the result(s) obtained on the interface screen for the user to judge.

The selection of results and the detailed operation of the system, in terms of processing the shooting result(s), will be discussed and described further in the text.

The main thing that is worth noting in a detailed description of the shooting method is the logging (saving) of data about the saving and deleting by the user of the shooting results and data about the distribution of the result in social media and the activity of interaction with it.

Wherein both types of data are logged with the consent of the user and at any time such consent can be revoked, and previously transferred data, with additional indication of this, can be deleted with the right of restoration within a period not exceeding 30 days.

Both types of data are used to identify candidates for the “shooting point” status, subsequent ranking and placement on the AR map, which will be discussed below, and for reinforcement learning globally within the network and developing an individual approach to the user.

Thus, the system can adapt to the user's preferences and learn from its “mistakes” (when the result of the shooting is sent to the “Deleted Items” folder) in order to subsequently anticipate and guess the creative ideas of the user of the device on which the system is installed.

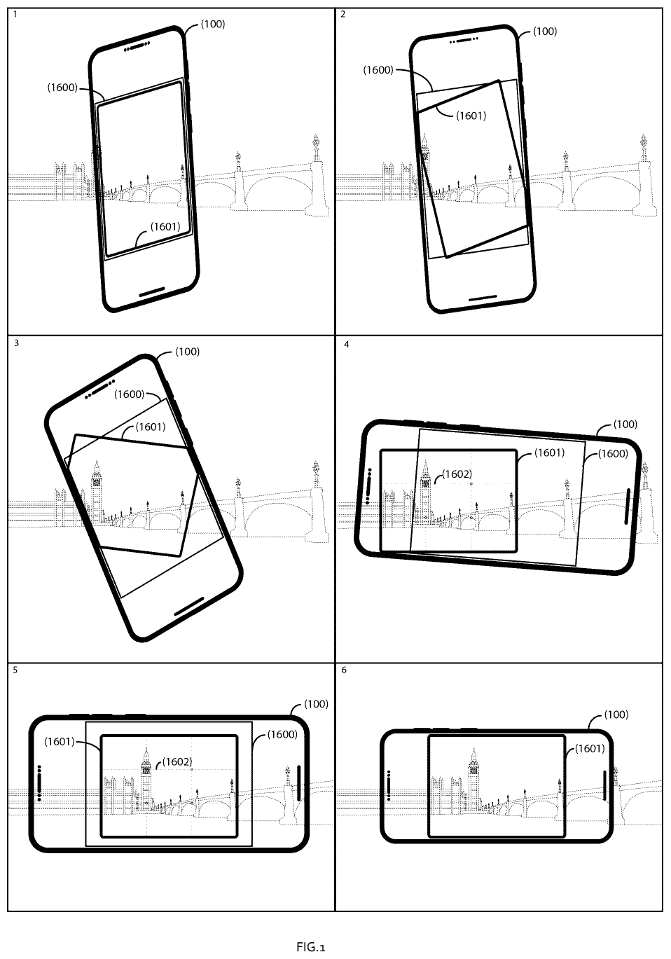

FIG. 1 illustrates the process of manipulating the device (100) in semi-automatic shooting mode.

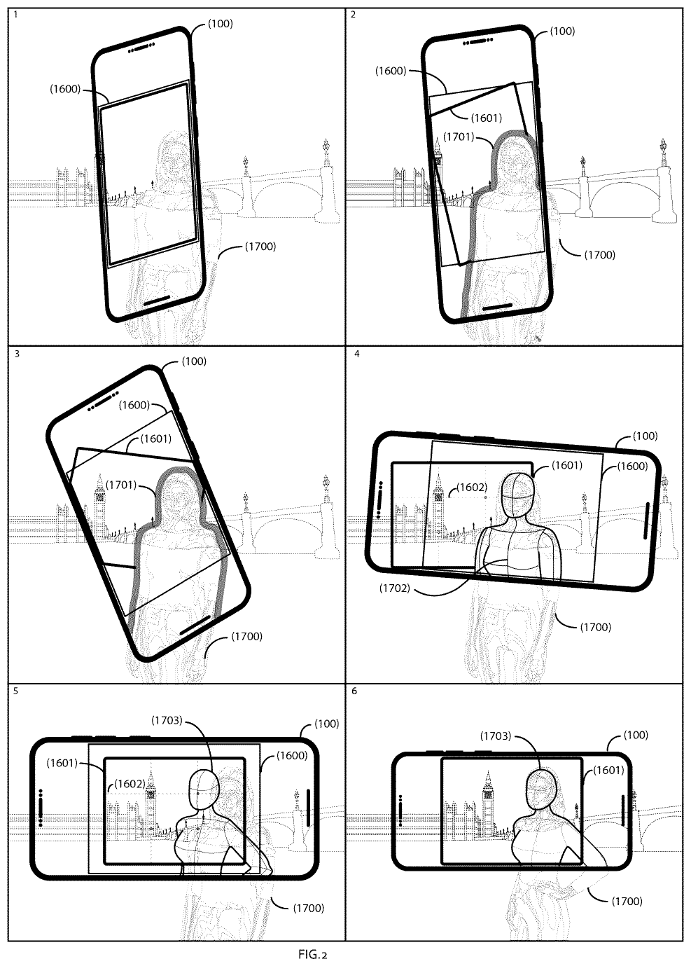

In order for the shooting to be carried out in semi-automatic mode, the operator needs to combine with each other (hereinafter-“overlay”), as sequentially demonstrated in frames 5 and 6 of FIGS. 1 and 2, the frame capture area (1600) of the device (100) and the target three-dimensional shot frame (1601), which is freely shifted to the location of the target shooting point in AR space, as sequentially demonstrated in frames 1, 2, 3, 4 of FIGS. 1 and 2.

At the moment of overlay, namely a couple of seconds before and a couple of seconds after, a series of shots and/or a video series is taken, from which the result is selected.

FIG. 2 as well as FIG. 1 illustrate the process of manipulating the device (100) in the semi-automatic shooting mode, only in the indicated example the scene of shooting a living object (1700) in the frame, a person, is added. Wherein a living object (1700) means not only a person, but also animals that can be recognized by CNNs.

When the system recognizes a live object (1700) in the focus in the coverage area, it highlights it (1701), as sequentially demonstrated in frames 1, 2, 3 of FIG. 2. If more than one living object (1700) is recognized and highlighted (1701) within the coverage area, the user can select the priority object (1700) for shooting by tapping on it on the device screen (100).

The system then graphically draws a 3D mannequin (1702) over the object, as demonstrated in frame 4 of FIG. 2.

And based on the received recommendations from the core, the mannequin (1702) animatedly changes the pose to a more flattering one (1703), as sequentially demonstrated in frames 4 and 5 of FIG. 2.

In addition to the above actions, to make portrait photography, in semi-automatic mode, the operator must advise the person—the subject of shooting (1700) to take the suggested flattering pose (1703) and/or try to catch the subject (1700) when he takes position corresponding to the proposed pose (1703).

It is worth noting that in the semi-automatic shooting mode, the priority is the overlap of the coverage area (1600) and the target three-dimensional frame (1601), and secondly, the matching of the subject's (1700) pose with a flattering pose (1703). Wherein the system will try to bring the shooting moment as close as possible when both tasks are completed.

At the moment of panning the shot and pointing the cameras at the desired subject, the incoming image stream is captured along with metadata. Simultaneously CNNs detect all objects in the frame, user portrait profiles, if any, their priority, position and distance, depth of field, scene illumination, external atmospheric conditions (weather, insolation and celestial navigation, etc.). After which the AI system core processes the input data and provides the system with options of the most successful combinations of composition and exposure. The best option in the form of a three-dimensional object of the target frame (1601) is shifted to the location of the target shooting point in AR space, as sequentially demonstrated in frames 1, 2, 3, 4 of FIGS. 1 and 12.

Delving into the details of the method, it is worth noting that the processes for obtaining data about the corresponding trained neural network model are consistent with the processes mentioned earlier. To simulate camera lenses that are not available on the device, so-called computer optical correction is used, which uses GANs models.

Thus, during core processing, the system in semi-automatic shooting mode can provide three outputs:
the possibility to create a shot is present, composition and exposure options are provided;
the creation of a shot is possible, for which the system needs more data (to expand the coverage area);
there is no possibility to create a high-quality, professionally staged shot, for example, when the image is completely out of focus, in which case the system switches to the guided shooting mode, which will be described in detail below.

In the case of the first output, the core transmits to the system the generated options of successful compositions and exposures, the best of which, according to the ranking result, in the form of a three-dimensional object of the target frame (1601) is shifted to the location of the target shooting point in AR space, as sequentially demonstrated in frames 1, 2, 3, 4 of FIGS. 1 and 2.

After the semi-automatic shooting process itself, described above, the obtained result is sent to the buffer of pre-saved results, where rapid post-processing occurs.

Then the system displays the obtained result(s) on the interface screen for the user to judge.

The selection of results and the detailed operation of the system, in terms of processing the shooting result(s), will be discussed and described further in the text.

The main thing to pay attention to is logging (saving) data, which was also described in detail above.

Next, let's review another tracking shooting mode.

In order for the shooting to be carried out in the tracking mode, the operator needs to stabilize, relative to the center point for both, and “overlay” one on the other the frame capture area (1600) of the device and the tracking (“swinging”) three-dimensional shot frame (1601), which is shifted relative to the center of the frame obviously for the operator, but not significantly from the point of view of the device interface, in accordance with the principles of panning, in the direction where the final shot should be captured, corresponding to the most successful composition and exposure. That is, the “tracking” process is carried out to the virtual location of the target shooting point in AR space, where the location of the target point is made without graphical representations on the screen, through slight shifts of the frame (1601).

At the moment of stabilization/centering and overlay, namely a couple of seconds before and a couple of seconds after, the system takes a series of shots and/or video series, from which the system selects the result.

The principle of creating portrait shots and/or other genre shooting of living objects (1700) in the tracking mode is fully consistent with the principle described above, applicable to semi-automatic shooting.

At the moment of panning the shot and pointing the cameras at the desired subject, the system actively captures the incoming image stream along with metadata. Simultaneously CNNs detect all objects in the frame, user portrait profiles, if any, their priority, position and distance, depth of field, scene illumination, external atmospheric conditions (weather, insolation and celestial navigation, etc.). After which the AI system core processes the input data and provides the system with options of the most successful combinations of composition and exposure. The best option is downloaded in the background mode at the location of the target shooting point in AR space, and is an invisible reference point for the displacement of the tracking (“swinging”) three-dimensional shot frame (1601), as sequentially demonstrated in frames 1, 2, 3, 4, 5, 6 of FIG. 1.

After the tracking shooting process itself, the obtained result(s) is (are) sent to the buffer of pre-saved results, where rapid post-processing occurs.

Then the system displays the obtained result(s) of shooting on the interface screen for the user to judge.

The selection of results and a detailed system operation algorithm in terms of processing the shooting result(s) will be discussed further in the text.

Delving into the details of the method, it is worth noting that the processes for obtaining data about the corresponding trained neural network model are consistent with the processes mentioned earlier. To simulate camera lenses that are not available on the device, so-called computer optical correction is used, which uses GANs models.

Thus, during core processing, the system in tracking shooting mode can provide three outputs:
the possibility to create a shot is present, composition and exposure options are provided;
the creation of a shot is possible, for which the system needs more data (to expand the coverage area), while visually the shot tilts and/or shifts relative to the center of the shot, indicating the direction to expand the camera's field of view;
there is no possibility to create a high-quality, professionally staged shot, for example, when the image is completely out of focus, in which case the system switches to the guided shooting mode, which will be described in detail below.

In the case of the first output, the core transmits to the system generated options of successful compositions and exposures, the best of which, based on the ranking result, is moved in the background mode to the location of the target shooting point in AR space, and is an invisible reference point for shifting of the tracking (“swinging”) three-dimensional shot frame.

After the tracking shooting process itself, the obtained result(s) is (are) sent to the buffer of pre-saved results, where rapid post-processing occurs, which is described in detail above.

Then the system displays the obtained result(s) on the interface screen for the user to judge.

The selection of results and the detailed flowchart of the system operation algorithm, in terms of processing the shooting result(s), will be discussed and described further in the text.

The main thing to pay attention to is logging (saving) data, which was also described in detail above.

Thus, all the above-described shooting modes of the disclosed method go through the same shooting process cycle.

Next, let's review the fourth shooting mode of the claimed method—the guided shooting mode.

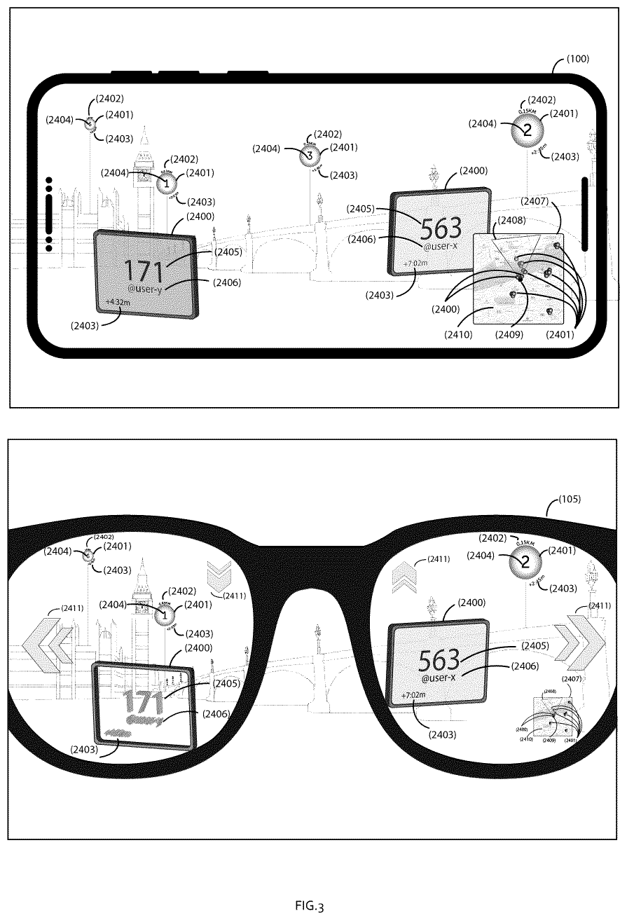

FIG. 3 illustrates the system interface in guided shooting mode with an active map of three-dimensional shooting points (angles) (2400) in augmented reality (hereinafter-AR map).

The user has three types of display of shooting points (2400) in the interface:

The first type is a 2D map (2410), which can be displayed full screen or as a thumbnail (2407), which by default is located at the bottom of the screen, but the user can drag it to any convenient location to provide better navigation across shooting points (2400).

The second type is an AR map projected onto the device screen (100) in the form of three-dimensional graphic and text elements (2400, 2401, 2402, 2403, 2404, 2405, 2406, 2407, 2408, 2409, 2410), complementing the real space, falling into camera lenses.

The third view is a mixed reality map, the mixed reality view displays three-dimensional shooting points on a connected mixed reality relay device (105) and wirelessly transmits guiding signals of graphic output (2411) to the projection screens of the mixed reality devices (105), directing the user to successful shooting angles and advising on how and in what position to hold the shooting device while the algorithm takes a shot.

Thus, FIG. 3 presents the following important elements as three-dimensional objects placed in augmented reality.

A shooting point (angle) (2400) is a three-dimensional object that can be made in the form of a three-dimensional frame, a digital device with a screen, a photograph, a bevel, etc. The user can select display types in the system settings, and the default is a simple digital frame. The shooting point (2400) exactly corresponds to the coordinates and position of the shot in space taken by the user (hereinafter—the author), not always by the user/operator of the device (100).

Points (2400) in their structure consist of metadata about the angle and position of the device (100) in space, camera settings at the time of shooting, as well as the level of social recognition of this point (the number of “repeated” shots taken at this point), which allows you to graphically recreate three-dimensional objects.

Points (2400) are displayed in augmented reality if they are within a radius of 50 meters from the operator. This parameter is set by default, and can be changed by the user at any time up to 1000 meters in the settings.

The following data are displayed within the point (2400): the public name of the point author (2406), the organic rating of the point (2405)—this is the number of photos that were taken (saved in the device memory (100) and/or posted on the Internet) by other system users, when interacting with the selected point, and the lifetime of the point (2403) is the remaining operating time of the point, taking into account the current data measured by the device (100), as well as the downloaded forecast data.

By tapping on the point (2400), one can view the original shot that was taken by the author (2406), posted on social media, view a brief overview of the author's account (2406), his rating in the system, other shots, subscribe (track) or send a request to chat for correspondence.

A group (cluster) of points (2401) is a three-dimensional object that can be made in the form of a three-dimensional ball, tablet, cube and other figures with a pointer perpendicular to the surface of the earth. The user can select display types in the system settings, and the default is a simple ball shape. Groups of shooting points (2401) are clusters of points (2400) in one place, which are displayed in augmented reality if they are within a radius of 50 meters to 10 kilometers from the operator. The first parameter of the near radius boundary is set by default, and can be changed by the user at any time starting from 1000 meters in the system settings.

Within the point group object (2401), a number displays the number of points (2404) in the group, and the distance from the operator to the point group (2402) is indicated next to it. Depending on the system of weights and measures selected in the settings, metric or imperial, the distance will be displayed in kilometers or miles. Also, the lifetime of a group of points (2403) is displayed nearby—this is the remaining operating time of the fastest point (2400) within the group (2401), taking into account the current data measured by the device (100), as well as downloaded forecast data.

After the lifetime (2403) of the oldest point has expired, the displayed number of points (2404) will decrease by one unit, while the lifetime (2403) of the group of points (2401) will be updated with the nearest lifetime of the next point (2400) in the group (2401).

Regardless of the position radius, all points can be found on the two-dimensional map (2410). There a point (2409) in the center can be seen, displaying the exact location of the device (100) and the coverage area and direction (2408) where it (100) is facing.

In popular places where there are potentially more than 10 points (2400) within a radius of 50 meters, and there are more than one active system users in the area of intersecting kilometer radii, the system will show each user no more than ten points (2400) at a time and these points (2400) will differ from each other and from the points (2400) that other system users see on the AR map.

Guiding graphics output signals (2411) to the projection screens of mixed reality devices (105) are located in two optical perception zones: foveal and peripheral. Foveal guides indicate how and in what position to hold the shooting device while the algorithm captures the shot. Peripheral guides, in turn, direct the user to the shooting points of selected successful angles.

After receiving confirmation from the AI core that it is not possible to shoot in automatic, semi-automatic or tracking mode, the system switches the operator to guided shooting mode and launches the AR card (FIG. 3). The operator searches for a suitable shooting point (2400) and can additionally obtain information about the point (2400) by tapping on it. After selecting the desired point (2400), the operator has to bring the device (100) closer to the point (2400) at a distance of thirty centimeters, and then the system will switch to one of the previously described shooting modes. Automatic, semi-automatic or tracking mode depends on the point (2400) and/or the selected preferences in the user settings. By default, the tracking mode is selected for the transition. The shooting processes in these modes were discussed in detail above. And based on the results of the shooting, the results are saved/deleted, and the sorting metadata is logged and used for reinforcement learning of the core. The guided shooting mode can also be used individually; the operator, after starting the system, can immediately select this mode.

The operation of the AR map (FIG. 3) of shooting points (2400) with interactive interaction and elements of social activity and network is supported by the central processor of the device (100), a server and a specialized software module for controlling the display of elements in augmented reality.

The AR map (FIG. 3) constantly monitors incoming data to provide up-to-date display of points (2400) in augmented reality. Thus, EXIF, GPS/GLONASS, visual odometry and exposure metering data coming from the labeled dataset DB provide an idea of the position and initial illumination of a point in space. Data on social media user activity interacting with posted shooting results in social media help correctly rank points (2400) to overcome threshold values by a perspective point (2400) in order to be positioned on the AR map (FIG. 3). Data on external atmospheric conditions (weather, illumination, celestial navigation, etc.) are loaded from open sources of weather conditions, insolation, celestial navigation via API, along with forecast values for seven days in advance, so as not to depend on the Internet connection, for updating the lifetime of points (2403).

As described above, points (2400), in guided shooting mode, can be displayed both on a two-dimensional map (2410), where all available points (2400) can be seen on the map, and in augmented and mixed reality mode, but taking into account the radius from operator: within a radius of up to 50 meters, it shows three-dimensional objects of shooting points (2400), with detailed interactive information about the point rating (2405), the author (2406) and the point lifetime (2403); within a radius of 50 meters to 10 kilometers from the operator, it shows three-dimensional objects of a cluster of points (2401), with detailed information about the number of points (2404), the distance to them (2402) and the lifetime of the group (2403).

The following describes the process of user interaction with the interface in the process of selecting the results obtained.

The output of the shooting result in the system interface for saving or deleting the obtained shooting result occurs immediately after the system has carried out shooting and rapid post-processing, and can be shown in the interface both with a horizontal and vertical screen orientation.

The result occupies the central area of the screen. The remaining areas, along the edges of the screen, are active (clickable) and, when tapped on once, instantly return the user to the current shooting mode, which continues to work in the background mode for another 10 seconds. Wherein the previously obtained result is stored in a special buffer folder in the application until the next session of outputting the results obtained and is put in a queue. Deferred results are not saved in the results folder on the device until the sorting procedure is completed, but are located in a temporary buffer, thereby preventing the photo roll from being cluttered with unnecessary shots.

While saving the shooting result(s) to the photo roll, the user drags (swipes) the result to the right, thereby instructing the system to save the provided result.

If there were several shooting results and/or results that require sorting have accumulated in the buffer folder, then these results will appear one after another after the saved result.

When deleting a shooting result(s), the user drags (swipes) the result to the left, thereby instructing the system to delete the provided result.

If there were several shooting results and/or results that require sorting have accumulated in the buffer folder, then these results will appear one after another after the deleted result.

The deleted result goes to the internal system storage inside the device and can be restored by the user for 30 days if it was deleted by mistake.

All metadata about the sorting of results are logged.

Next, let's review the system operation in terms of processing the shooting result(s).

After saving/deleting the results, logging (accounting) is kept of data about the saving and deleting by the user of the shooting results and data about the distribution of the result in social media and the activity of interaction with it.

Both types of data are logged with the consent of the user and at any time such consent can be revoked, and previously transferred data, with additional indication of this, can be deleted with the right of restoration within a period not exceeding 30 days.

Both types of data are used by the system: to identify candidates for the status of “shooting point”, subsequent ranking and placement on the AR map (FIG. 3) and for reinforcement learning globally within the network and developing an individual approach to the user. Thus, the system can adapt to the user's preferences and learn from its “mistakes” (when the result of the shooting is sent to the “Deleted Items” folder), and metadata about successful shots, as well as data about successful lens imitation, are added to user genre datasets in order to subsequently anticipate and guess the creative ideas of the user of the device on which the system is installed.

The neural models and GANs trained in this way are continuously updated, thereby improving the deep machine learning of the core, the shooting result and the user experience of interacting with the system, both globally within the network and personalized.

Next, let's review the processes and tasks that are processed on the server. The DB of labeled datasets is constantly synchronized with devices, updated and replenished. At the same time, to simulate camera lenses that are not available on the device, they use the so-called computer optical correction, which uses GAN models.

Data about their use in creating results is logged and synchronized with labeled datasets.

Also on the server, in addition to the constantly training AI core, data on interaction with shooting results in social media are collected and logged, and based on these data, the system learns, which increases the user experience of interaction with shooting modes, incl. guided shooting in augmented reality.

Cloud computing is necessary for fundamental calculations and global reinforcement learning on data collected from all devices and other sources throughout the day. The server part constantly updates the core and this is the only possibility to update and improve the system by those users who, guided by personal considerations of security and privacy, have prohibited the data exchange with the system cloud, while they consciously refuse to personalize the system to their preferences.

At the end of the disclosure of the application, it is definitely worth considering the key feature of the system, which is described as part of the general flowchart of the interaction of AI system cores on devices using edge AI technologies, their data exchange process in the system network and the Internet and channels for distributing computing power between devices, using fog computing. Using edge AI technologies, all calculations within the internal cores are performed on the devices themselves (100), which in turn are able to directly establish data exchange channels, which ensures not only the speed of exchange of labeled and processed data, but also allows using the possibilities of distributing computing power between devices, significantly speeding up the data processing. Wherein the structure also invariably comprises a cloud core hosted on the system's servers, communication with which and exchange of data occur through Internet channels.

Thanks to this structure, as the network grows, users will be able to carry out shooting of any complexity as autonomously and quickly as possible without delays.

These application materials disclosed the preferred embodiment of the claimed technical solution, which should not be used to limit its other, particular embodiments that are within the scope of the claimed legal protection and are obvious to those skilled in the relevant art.

1. A computer-implemented method of photo or video shooting with a digital device comprising at least one optical device, based on providing recommendations for professional framing, comprising the stages of:
receiving a data stream through the optical device on the digital device;
processing the data stream using machine learning techniques using models trained on a plurality of images including at least composition information to recommend the best shot;
shooting in automatic, semi-automatic, tracking shooting and guided shooting modes;
wherein, in automatic mode, the shooting process is initiated by tapping on any area of the screen; in semi-automatic or tracking mode, shooting is carried out by combining the frame capture area and the three-dimensional frame of the shot; if in the automatic, semi-automatic and tracking modes there is no possibility to create a professionally composed shot, then the guiding shooting mode is turned on, in which three-dimensional shooting points are generated into an interactive real-time map for each user individually, with each point containing interactive information for obtaining a professionally composed shot, while the map is a 2D map or an AR map and/or a mixed reality map;
the mixed reality view displays three-dimensional shooting points on a connected mixed reality relay device and wirelessly transmits guiding signals of graphic output to the projection screens of the mixed reality devices, directing the user to successful shooting angles and advising on how and in what position to hold the shooting device while the algorithm takes a shot;
sending the shots obtained during shooting, in at least one of the modes, to the buffer of pre-saved shooting results, where rapid post-processing is carried out and the resulting shooting result is displayed on the screen;
further interacting with the results are recorded and processed using reinforcement learning methods to further improve shooting processes and results.

2. The method according to claim 1, characterized in that the optical device is a camera.

3. The method according to claim 2, characterized in that it comprises at least one camera.

4. The method according to claim 1, characterized in that the data stream contains at least metadata, including EXIF.

5. The method according to claim 1, characterized in that an individual portrait profile is created by scanning the face and at least one flattering posing option is determined.

6. The method according to claim 5, characterized in that when detecting a living object in the frame that corresponds to a configured individual portrait profile, the parameters of this profile will be taken into account when shooting.

7. The method according to claim 6, characterized in that when detecting more than one living object in the frame, a living object with a saved portrait profile is selected first.

8. The method according to claim 1, characterized in that in the automatic shooting mode, when tapping on any part of the screen, the finger is held and the digital device is moved in different planes and directions.

9. The method according to claim 8, characterized in that the shooting result is displayed on the screen when the finger is lifted.

10. The method according to claim 1, characterized in that, in the semi-automatic shooting mode, the three-dimensional frame is a fixed reference point.

11. The method according to claim 1, characterized in that, in the semi-automatic shooting mode, a three-dimensional shot frame moved and fixed in space is used as a reference point and the frame capture area and the three-dimensional shot frame are overlapped.

12. The method according to claim 1, characterized in that, in the semi-automatic shooting mode and tracking shooting mode, when a living object is detected in the focus coverage area, it is highlighted with an outline, then a three-dimensional mannequin is graphically drawn on top of the object and the mannequin animatedly changes its pose to a more flattering one.

13. The method according to claim 12, characterized in that if more than one living object is detected, the user can select a priority object.

14. The method according to claim 1, characterized in that, in the tracking shooting mode, the three-dimensional frame is a tracking frame.

15. The method according to claim 1, characterized in that, in the tracking shooting mode, the tracking frame capture area and the tracking three-dimensional shot frame of the shot are stabilized relative to the central point and overlapped.

16. The method according to claims 11 and 15, characterized in that a couple of seconds before and after stabilization and overlapping, shot and/or video sequences are taken.

17. The method according to claims 11 and 15, characterized in that a three-dimensional frame indicates the orientation of the camera for obtaining a professionally composed shot.

18. The method according to claim 1, characterized in that the operator can select the guided shooting mode after starting the system.

19. The method according to claim 1, characterized in that, in the guided shooting mode, a map is launched, where the user selects the desired point, moves the device closer to this point, and automatically switches the shooting mode to the one saved at this point.

20. The method according to claim 1, characterized in that, a two-dimensional map displaying three-dimensional shooting points can be displayed in full screen or as a thumbnail; the thumbnail can be moved to any location on the screen.

21. The method according to claim 1, characterized in that the AR map indicates shooting points taking into account the radius to them: within a radius of up to 50 meters, a three-dimensional object of the shooting point is shown with detailed interactive information, such as: information about the point rating, information about the point author, information about the point lifetime; within a radius of 50 meters to 5 kilometers, three-dimensional objects of a cluster of shooting points are displayed with detailed information, such as information on the number of points in the cluster, the distance to the cluster of points and information on the lifetime of the cluster of points.

22. The method according to claim 1, characterized in that the display of the shooting result occupies the central part of the screen, wherein free areas of the screen remain active and return to the mode used for shooting upon tapping on these active areas.

23. The method according to claim 22, characterized in that, the obtained shooting result is stored in a buffer until the next session for outputting the shooting results, which are queued for sorting.

24. The method according to claim 23, characterized in that to save the shooting result, the shooting result is dragged to the right.

25. The method according to claim 23, characterized in that to delete the shooting result, the shooting result is dragged to the left.

26. The method according to claim 1, characterized in that when interacting with shooting results, training can be carried out both on the device and on the server.

27. A computer-readable medium containing instructions executable by a processor, wherein the processor is configured to implement the steps of the method according to claims 1-26.
